(19) United States
(12) Patent Application Publication
(10) Pub. No.: US 2014/0254814 A1
(43) Pub. Date: Sep. 11, 2014

(54) Electronic Stethoscope

(71) Applicant: David A. Van Alstine, Memphis, TN (US)

(72) Inventor: David A. Van Alstine, Memphis, TN (US)

(21) Appl. No.: 14/200,007

(22) Filed: Mar. 6, 2014

Related U.S. Application Data
(60) Provisional application No. 61/773,357, filed on Mar. 6, 2013.

(51) Int. Cl. H04R 23/00

(52) U.S. Cl. CPC H04R 23/00
USPC 381/67

(57) ABSTRACT

A portable ergonomic compact handheld stethoscope to aid in the listening of internal body sounds.

### CROSS-REFERENCE TO RELATED APPLICATIONS

This application claims the benefit of U.S. Provisional Application No. 61/773,357, filed Mar. 6, 2013.

### FIELD OF THE INVENTION

This invention relates to stethoscopes.

### BACKGROUND OF THE INVENTION

The current stethoscopes are constructed with a length of hollow tubing extending from two ear pieces to a diaphragm having a length of approximately 3 feet. These stethoscopes are generally awkward to carry and when stored on the user's pocket, are difficult to store upon one's person, catching going in and out of pocket. If worn around the person's neck, as so often is done by medical professionals working in and around a patient care facility, they chaff the user's neck, wear on neck and heavy. Stethoscopes are such a necessary tool for routine patient diagnostics, yet at the same time a troubling nuisance to the user and wearer, some medical professionals refer to them as “the flea collar” as they are often worn around the neck.

The traditional stethoscope is larger than necessary for the job in order to allow the medical professional to hear the patient's internal sounds while maintaining a comfortable distance. Unfortunately the fixed length, while creating a cumbersome bundle of semi-rigid tubing is still at times too short and creates a general disadvantage in many situations.

Traditional stethoscopes often lack advanced features. Generally no audio capture is possible and lack the ability to share the audio for teaching. They lack noise reduction capabilities, making unwanted distracting sounds as audible as those sounds of interest. Traditional stethoscopes lack noise amplification.

While some traditional stethoscopes offer the ability to hear different sounds by incorporating a diaphragm on one side and a bell on the other side, such devices require the user to move device to change from diaphragm to bell, making it difficult to easily acquire the same listening position on the body.

Part of patient care often involves informing a patient of the ailment and treatment choices. The ability for the patient to observe what the physician observes greatly aids in the patients understanding of the diagnosis and treatment. Traditional stethoscopes lack a speaker for sharing with patient or other listeners what is important.

While the current stethoscopes are limited in their abilities, the good models, capable of functioning as acceptable stethoscopes are expensive while cheap models are almost worthless to use. Even with the variety in quality available, the variety of colors and designs are generally limited, making wearing the device even less appealing.

A need exists for a compact, easy to carry stethoscope that allows a user to electronically manipulate the sounds, amplifying desired sounds while eliminating unwanted ones, allow the user to share what they are hearing with others for teaching or informing and allow the user the ability to personalize the device to suit their personal sense of style thereby increasing the likelihood that the user will carry it when needed and increase the likelihood that they will like the model they are forced to carry.

### BRIEF SUMMARY OF THE INVENTION

The current invention is an electronic stethoscope packaged in a single compact device. In the embodiment, the electronic stethoscope comprises of an electronic microphone, a push button on and off switch with the ability to switch to “bell mode” and a rocker switch for volume. A stereo phone jack allows a user to listen with any ear buds so one can select an aftermarket pair that can be personalized for style and comfort.

An ergonomically shaped exterior having finger grooves assists positioning of the device upon a patient's body. The grooves also allow the audio cord to wrap around middle pillar.

A smooth contoured outer surface allows the contact surface to easily wipe clean. A built in speaker output allows for sharing and quick use while an optional radio transmitter, such as a Blue Tooth connection allows for wireless configuration to wireless headphones, a computer or other electronic device.

The case design allows for multiple color choices giving user's ample opportunity for customization. The ability to package different electronics within the same general ergonomic shape allows for several grade models from a simple limited functions model to a professional or multi-functional model having more complex abilities.

The size of the device allows for common batteries such as AAA size batteries, or for additional space, or a more compact package, a smaller battery such as a watch battery could be used.

The presence of a headphone jack allows the audio output to go to external speakers or a splitter for multiple headphone or ear bud use.

The compact size enables it to be worn like a traditional electronic device. Preferably the user can use a carrying case that clips to clothes like cell phone which will be familiar to nearly all users due to the popularity of current phones and electronic devices such as iPods.

Various embodiments of the invention are shown and described, including a Military grade version with covers for ports and constructed from hardened material, a professional version with high end audio and switch to diaphragm or bell, a midgrade version with good acoustics and lower cost, and a simple grade for crash carts, limited use environments or home use, an EMT grade version with headphone audio and superior noise cancelling, a precordial version for OR anesthesia—pediatrics, or even an espionage version with suction cup surface and wireless transmission.

The invention has a broad market including: physicians, nurses, physician assistants and nurse practitioners, EMTs, veterinarians, military field use, especially forward teams.

### BRIEF DESCRIPTION OF THE DRAWINGS

FIG. 1 is a bottom view of the first embodiment of the invention.

FIG. 2 is a side view of the first embodiment of the invention.

FIG. 3 is a top view of the top portion of the first embodiment of the invention.

FIG. 4 is a side view of the top portion of the first embodiment of the invention.

FIG. 5 shows a side view of a second embodiment of the invention.

FIG. 6 shows a side view of a third embodiment of the invention.

FIG. 7 shows a rear perspective view of the second embodiment of the invention.

FIG. 8 shows a right front perspective view of the first embodiment of the invention.

FIG. 9 shows a rear perspective view of an embodiment of the invention being held by a user.

FIG. 10 shows a right rear perspective view of an embodiment of the invention being held by a user.

FIG. 11 shows a top view of an embodiment of the invention.

FIG. 12 shows a front view of an embodiment of the invention being held by a user.

FIG. 13 shows a right front perspective view of an embodiment of the invention.

FIG. 14 shows a right rear perspective view of an embodiment of the invention.

FIG. 15 shows the first embodiment of the invention in black, the second embodiment of the invention in camouflage and a third embodiment of the invention customized in sparkly glitter red and a pair of ear buds.

FIG. 16 shows the first embodiment with a pair of ear buds plugged into the earphone jack.

FIG. 17 shows a block diagram of the internal electronics of an embodiment of the device.

### DETAILED DESCRIPTION OF THE INVENTION

FIG. 1 is a bottom view of the first embodiment of the invention. The bottom of this embodiment contains the sound transducer for receiving sound signals when placed upon a surface, such as a patient's chest or back. The smooth minimizes crevasses making it easy to clean.

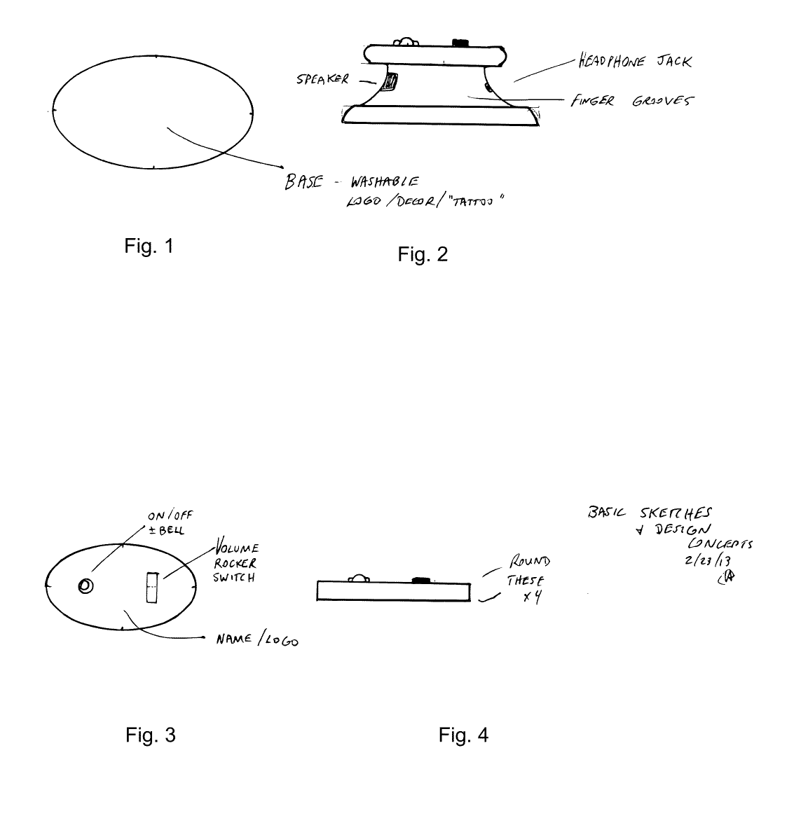

FIG. 2 is a side view of the first embodiment of the invention. A small speaker is contained in the front of the device, while a headphone jack is placed in the rear of the device. In the embodiment, the headphone jack is a standard stereo ⅛ inch diameter headphone jack. The sides of the invention are contoured allowing the user to easily grip the device.

FIG. 3 is a top view of the top portion of the first embodiment of the invention. The top contains a switch to turn the device on or off. In advanced versions of the device, the switch may also be used to select the diaphragm function or bell function to simulate the use of a traditional diaphragm stethoscope or a bell stethoscope. A volume switch, preferably a rocker switch, is also contained within the top portion of the device.

FIG. 4 is a side view of the top portion of the first embodiment of the invention. The on/off switch and volume switch are shown protruding above the top surface of the top portion of the device in the embodiment. The lower portion and middle pillar are not shown in FIG. 3 or 4.

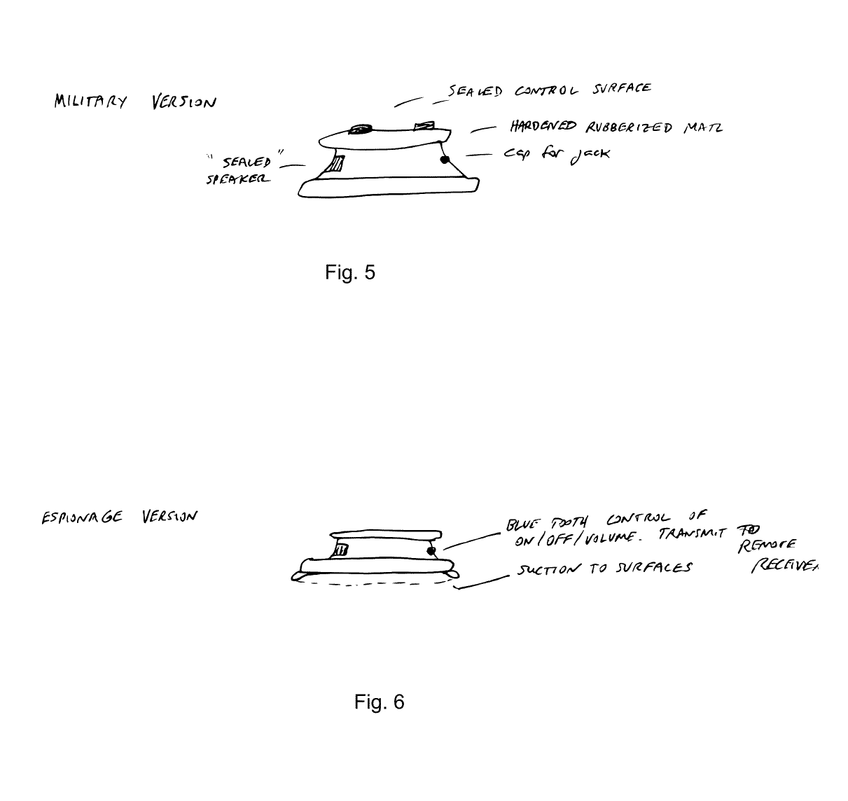

FIG. 5 shows a side view of a second embodiment of the invention intended for rough use, such as may be necessary for military field use. The controls and speakers are sealed and the headphone jack is capped to prevent the ingress of liquids. The second embodiment would be constructed from a durable hardened rubberized material. The second embodiment could be constructed from a composite or reinforced plastic bonded with a rubber material.

FIG. 6 shows a side view of a third embodiment of the invention intended for use on a surface for eavesdropping. The third embodiment would possess a suction cup-like bottom for temporarily attaching to smooth surfaces, such as glass windows or smooth walls. A wireless transmitter integrated into the device, such as a Bluetooth wireless transmitter, would enable the device to transmit signals to a remote location. The controls would be relocated from the top, to the pillar surface reducing the height of the device and making it less noticeable.

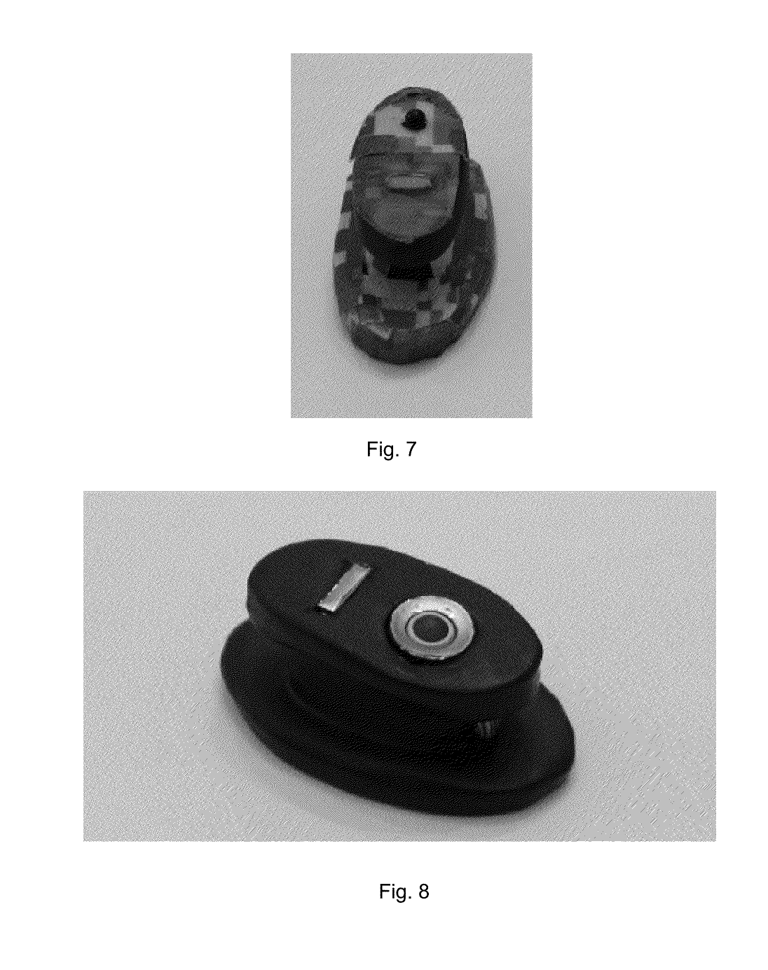

FIG. 7 shows a rear perspective view of the second embodiment of the invention showing a military style appearance treatment. The devices small size makes it convenient for field medics and other personnel to carry. A matt, non-reflective finish maintains the user's concealment and reduces the device becoming a beacon for enemy fire. A sealed surface ensures reliability in humid, damp and wet conditions.

FIG. 8 shows a right front perspective view of the first embodiment of the invention. The rectangular volume toggle switch, round on/off switch, and front speaker can be seen. The bottom base portion is preferably slightly larger than the top portion, which aids the user in orienting the device upon the patient or intended listening surface.

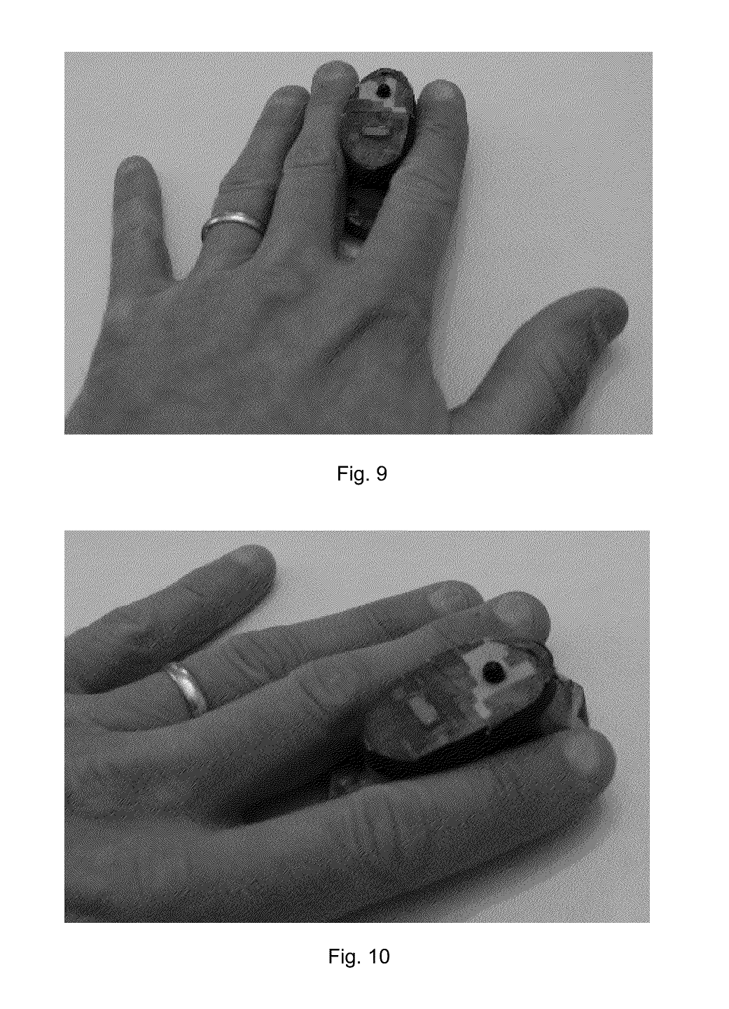

FIG. 9 shows a rear perspective view of an embodiment the invention being held by a user. The pillars and wider bottom base portion and widened top portion allows the device's middle pillar to be cradled between the user's fingers. The curved shape allow the user to maintain control and reduce the likelihood of dropping the device.

FIG. 10 shows a right rear perspective view of an embodiment of the invention being held by a user. The elongated shape allows the sides of the pillar to be positioned along the user's fingers, helping the user maintain the orientation of the device.

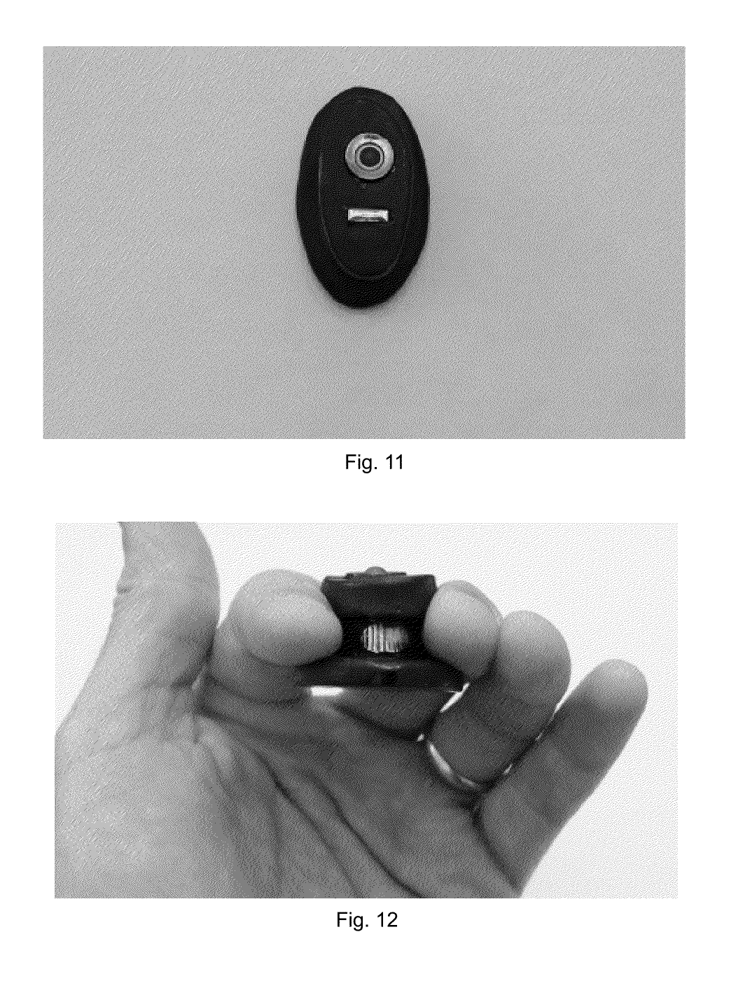

FIG. 11 shows a top view of an embodiment of the invention.

FIG. 12 shows a front view of the invention being held by a user. The reduced thickness of the middle pillar allows the fingers to easily grip the device.

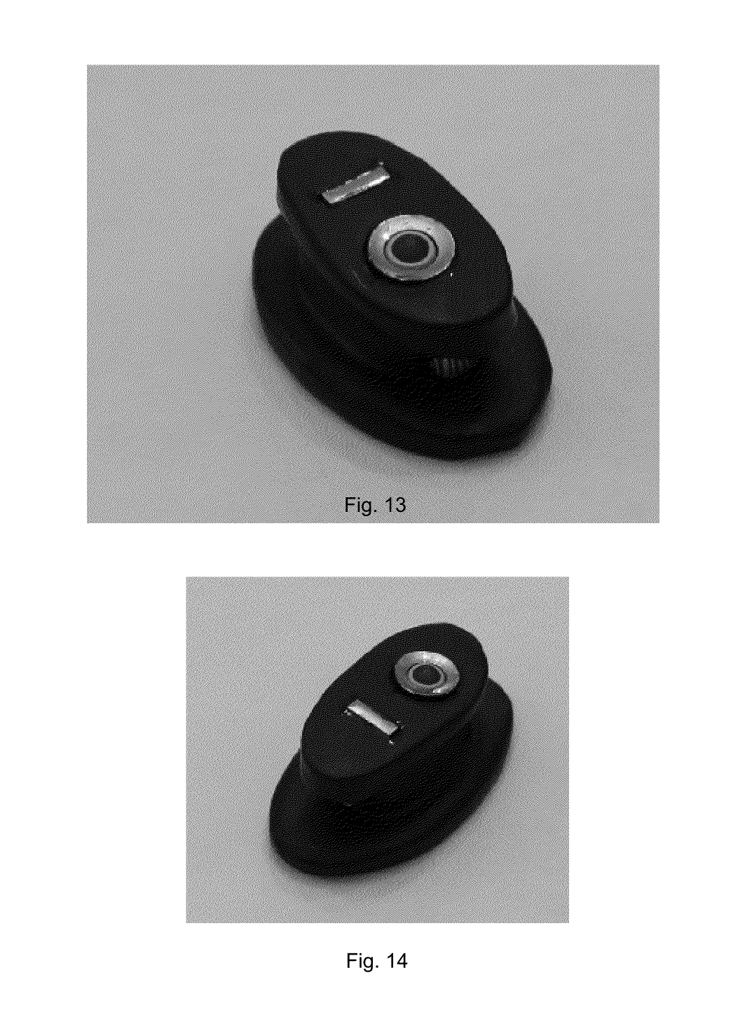

FIG. 13 shows a right front perspective view of an embodiment of the invention.

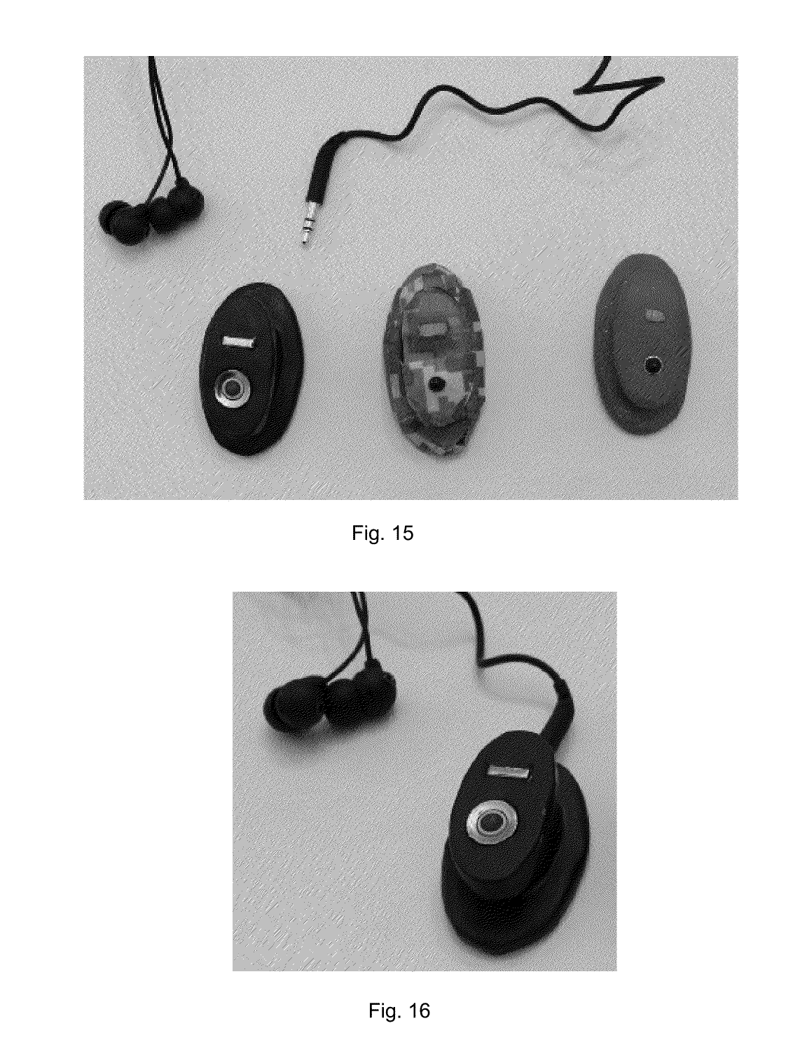

FIG. 14 shows a right rear perspective view of an embodiment of the invention.

FIG. 15 shows the first embodiment of the invention in black, the second embodiment of the invention in camouflage and a third embodiment of the invention customized in sparkly glitter red and a pair of ear buds. The use of a standard headphone jack enables the user to use his or her brand or style listening device, such as the ear buds shown here, enclosed earphones, or even an external amplified speaker.

FIG. 16 shows the first embodiment with a pair of ear buds plugged into the earphone jack.

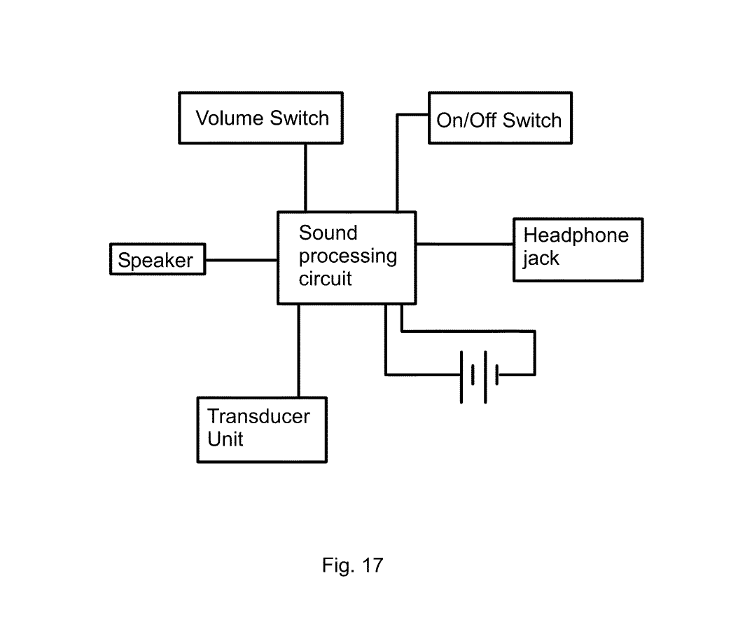

FIG. 17 shows a block diagram of the internal electronics of the embodiment of the device. The electronics of the device are contained within the device's body, with the exception of the ear buds that may be connected through a headphone jack. The device possesses a sound processing circuit capable of amplifying the sound. A speaker connected to the sound processing circuit would allow the signal to be heard by multiple listeners, while a headphone jack would allow the device to be plugged into headphones for an individual user's listening. Control buttons, such as the volume switch and on/off switch would control the sound processing circuit's functions, including the option to change vary the processing of the sound signals to simulate a traditional stethoscope's diaphragm or bell functions.

1. An electronic stethoscope having an elongated shape comprising:
a top portion;
a middle pillar portion positioned below said top portion;
a bottom portion positioned below said middle pillar portion;
an on/off switch positioned upon the top surface of said top portion;
a volume switch control positioned upon the top surface of said top portion;
a transducer unit for receiving sound signals;
a sound processing circuit for signal processing;
a power source; and
a speaker;
whereas said middle pillar portion is narrower than said top portion and said bottom portion allowing a user to easily grip the device between the user's fingers, the user able to turn the device on or off with said on/off switch, the user able to select between electronic signal processing of the received sound to simulate bell and diaphragm function of a traditional stethoscope.

2. The electronic stethoscope of claim 1 wherein said sound processing circuit processes said sound signals received by said transducer and said speaker produces an amplified signal.

3. The electronic stethoscope of claim 1 wherein said sound processing circuit amplifies said sound signals received by said transducer.

4. The electronic stethoscope of claim 1 wherein said sound processing circuit records said sound signals received by said transducer.

5. The electronic stethoscope of claim 3 wherein said volume switch controls the gain of said amplification.

6. The electronic stethoscope of claim 1 wherein said stethoscope is used to listen to bodily functions.

7. The electronic stethoscope of claim 1 wherein said stethoscope is used to listen to mechanical sounds.

8. The electronic stethoscope of claim 1 wherein said stethoscope is used to listen to conversations.
